(19) United States
(12) Patent Application Publication
(10) Pub. No.: US 2010/0180811 A1
(43) Pub. Date: Jul. 22, 2010

(54) WATER LEVEL DETECTOR

(76) Inventor: George Sotiriou, Farmingville, NY (US)

Correspondence Address: BRAKE HUGHES BELLERMANN LLP, c/o CPA Global, P.O. BOX 52050, MINNEAPOLIS, MN, 55402, US

(21) Appl. No.: 12/357,092

(22) Filed: Jan. 21, 2009

(51) Int. Cl. B63B 17/00; G08B 21/00; B60P 3/22

(52) U.S. Cl. 114/343; 340/623; 220/562

(57) ABSTRACT

According to one example embodiment, an apparatus may include a chamber, a flotation device inside the chamber, a magnetic sensor circuit, a timing circuit, and a switch circuit. The chamber may be configured to receive water through a first opening and allow water to exit through a second opening. The chamber may also be configured to prevent water from exiting the chamber other than through the first opening or the second opening. The flotation device may include a magnetic material. The magnetic sensor circuit may be configured to determine whether the flotation device is in proximity with a top portion of the chamber. The magnetic sensor circuit may be configured to output a water level signal to a timing circuit based on the determining. The timing circuit may be configured to output an alarm signal to a switch circuit based on the water level signal continually indicating a low water level for a predetermined period of time. The switch circuit may be configured to remove power from an external device based on the alarm signal.

### TECHNICAL FIELD

This description relates to detecting water levels.

### BACKGROUND

Water pumps may be used to transport water from one area to another. The pumps may, for example, provide water for drinking or cleaning, or to remove water which has splashed onto a boat. If the water level traveling through the pump falls below a threshold level, the pump may lose “prime.” If the pump continues to operate after it has lost prime, the pump may be damaged.

### SUMMARY

According to one general aspect, an apparatus may include a chamber, a flotation device inside the chamber, a magnetic sensor circuit, a timing circuit, and a switch circuit. The chamber may be configured to receive water through a first opening and allow water to exit through a second opening. The chamber may also be configured to prevent water from exiting the chamber other than through the first opening or the second opening. The flotation device may include a magnetic material. The magnetic sensor circuit may be configured to determine whether the flotation device is in proximity with a top portion of the chamber. The magnetic sensor circuit may be configured to output a water level signal to a timing circuit based on the determining. The timing circuit may be configured to output an alarm signal to a switch circuit based on the water level signal continually indicating a low water level for a predetermined period of time. The switch circuit may be configured to remove power from an external device based on the alarm signal.

According to another general aspect, a boat may include a hull, at least one water tank, a pump, and a water level detector. The hull may be configured to cause the boat to float. The at least one water tank may be configured to store water. The pump may be configured to pump water from the at least one water tank. The water level detector may be configured to receive the water being pumped by the pump from the at least one water tank. The water level detector may include means for detecting whether a water level of the water being pumped by the pump from the at least one water tank has fallen below a predetermined threshold, means for determining whether the water level has fallen below the predetermined threshold for a predetermined period of time, and means for removing power from the pump based on the water level falling below the predetermined threshold for the predetermined period of time

The details of one or more implementations are set forth in the accompanying drawings and the description below. Other features will be apparent from the description and drawings, and from the claims.

### BRIEF DESCRIPTION OF THE DRAWINGS

FIG. 1 is a block diagram of a vehicle including a water level detector and the pump showing water supply lines according to an example embodiment.

FIG. 2 is a block diagram of a system including the water level detector, the pump, and a horn showing electrical supply lines according to an example embodiment.

FIG. 3 is a block diagram of the water level detector according to an example embodiment.

FIG. 4 is a circuit diagram of a sensor circuit according to an example embodiment.

FIG. 5 is a circuit diagram of a timing circuit according to an example embodiment.

FIG. 6A is a circuit diagram of a switch circuit according to an example embodiment.

FIG. 6B is a circuit diagram of the switch circuit in a normal state according to an example embodiment.

FIG. 6C is a circuit diagram of the switch circuit in an alarm state according to an example embodiment.

FIG. 7 is a circuit diagram of a DC circuit according to an example embodiment.

FIG. 8 is a circuit diagram of an AC circuit according to an example embodiment.

### DETAILED DESCRIPTION

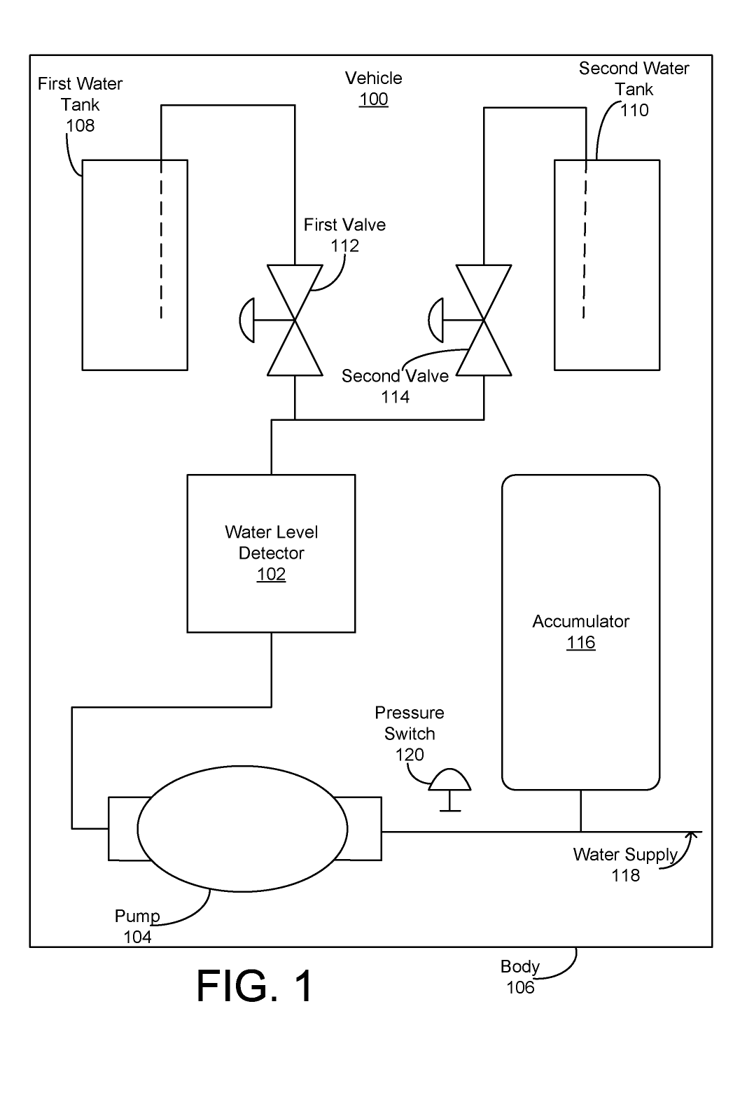

FIG. 1 is a block diagram of a vehicle 100 including a water level detector 102 and a pump 104 showing water supply lines according to an example embodiment. The vehicle 100 may include, for example, a recreational vehicle, such as a truck with a camper, or a boat or ship. The vehicle 100 may include a body 106. The body 106 may include, for example, a frame or a hull, and, in the example in which the vehicle 100 includes a boat or ship, may be waterproof and allow the vehicle 100 to float.

The vehicle 100 may include one or more tanks for storing water. In the example shown in FIG. 1, the vehicle 100 includes a first water tank 108 and a second water tank 110. Each of the water tanks 108, 110 may store water for drinking or cleaning. The vehicle 100 may also include valves, such as a first valve 112 and a second valve 114, for controlling the flow of water from the water tanks 108, 110. In an example embodiment, a user may open the first valve 112 to allow water to flow from the first water tank 108, or may open the second valve 114 to allow water to flow from the second water tank 110.

The pump 104 may pull the water from either or both of the tanks 108, 110. In an example embodiment, the vehicle 100 may include an accumulator 116. The accumulator 116 may hold or store the water pulled by the pump 104, ensuring a steady water supply 118 even if the pump 104 is pumping water only intermittently. The vehicle 100 may also include a pressure switch 120, which may control upper and lower pressure limits of the accumulator 116, and which may thereby control the water pressure of the water supply 118. The pressure switch 120 may, for example, cause the pump 104 to start pumping when the water pressure drops below a lower threshold, such as 30 pounds per square inch (PSI), and may cause the pump 104 to stop pumping when the water exceeds an upper threshold, such as 50 PSI.

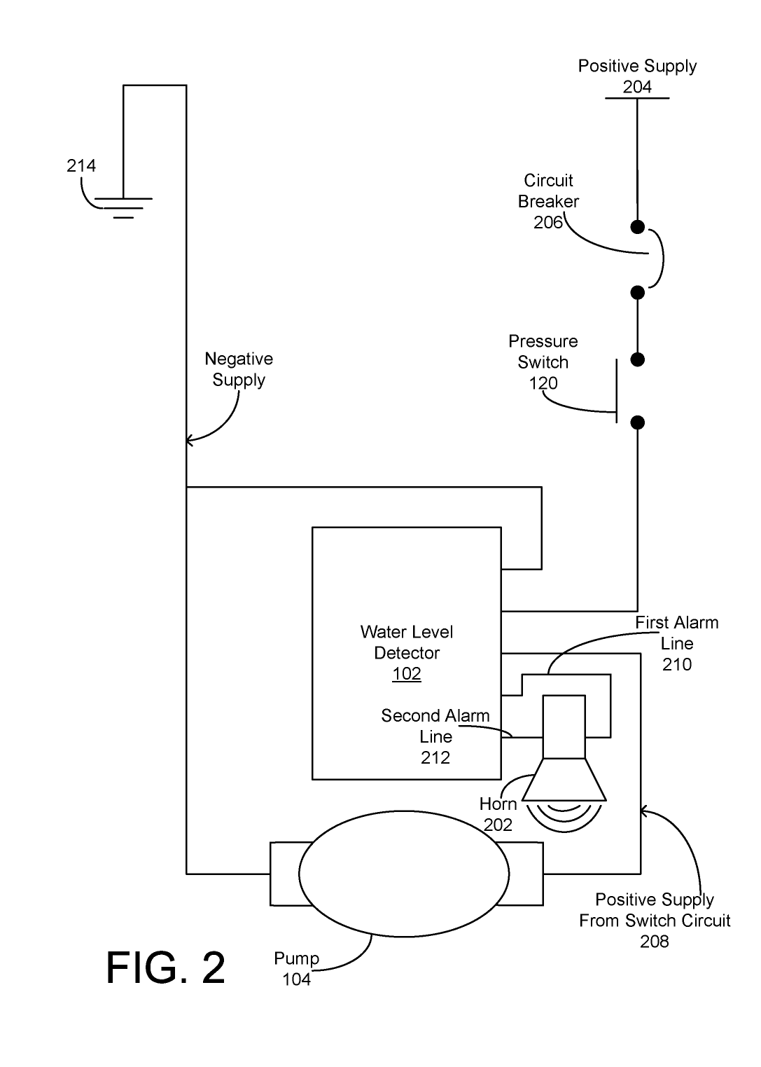

The water level detector 102 may receive water from the water tanks 108, 110 either before or after the water passes through the pump 104. The water level detector 102 may indicate that power is available for operation, such as with a visual status indicator such as a green light-emitting diode (LED), and/or may supply power to the pump 104. The water level detector 102 may detect the water level, and if the water level drops below a threshold for a predetermined time (such as 3.75, 7.5, 15, 30, 60, 120, or 240 seconds), the water level detector 102 may indicate the drop, such as with a visual status indicator such as a red LED and/or an audible alarm such as a horn, and/or may cease supplying power to the pump 104. The water level detector 102 may prevent power from being supplied to the pump 104 until the water level detector 102 and/or the pump 104 has been reset, such as by tripping a circuit breaker (shown in FIG. 2), according to an example embodiment.

FIG. 2 is a block diagram of a system including the water level detector 102, the pump 104, and a horn 202 showing electrical supply lines according to an example embodiment. The water level detector 102 may receive power from a positive power supply 204, which may include a power source such as a battery. A circuit breaker 206 between the power supply 204 and the water level detector 102 may prevent power surges from damaging the water level detector 102. The pressure switch 120 may be located between the power supply 204 and the water level detector 102, and/or in series with the circuit breaker 206, and may supply or take power away from the water level detector 102 based on the water pressure, as described above.

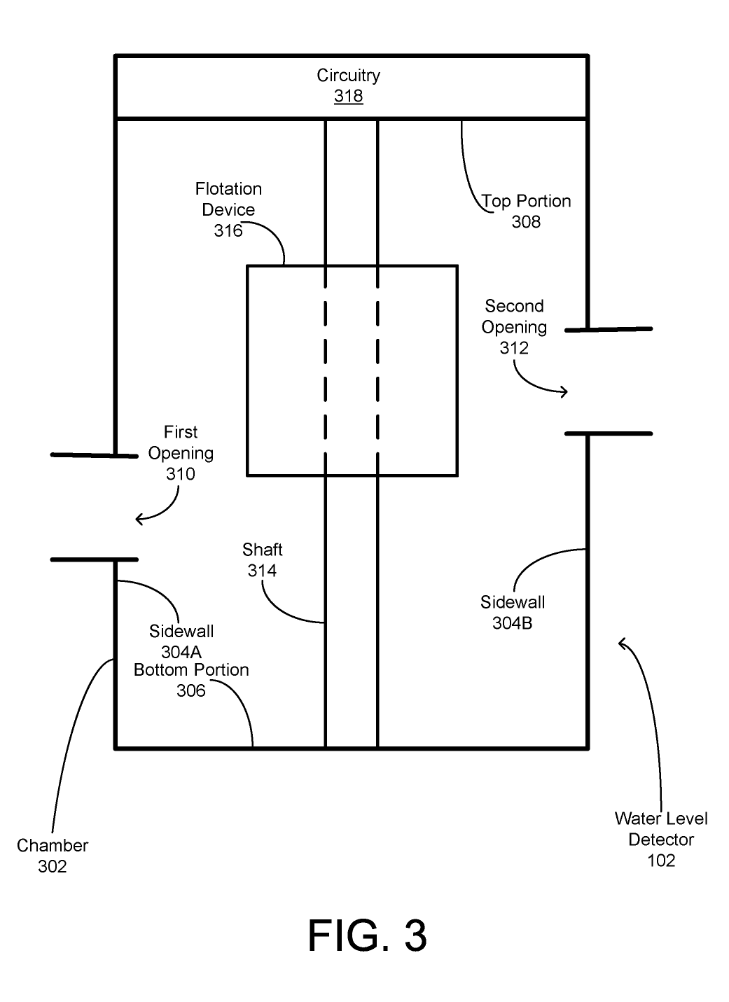

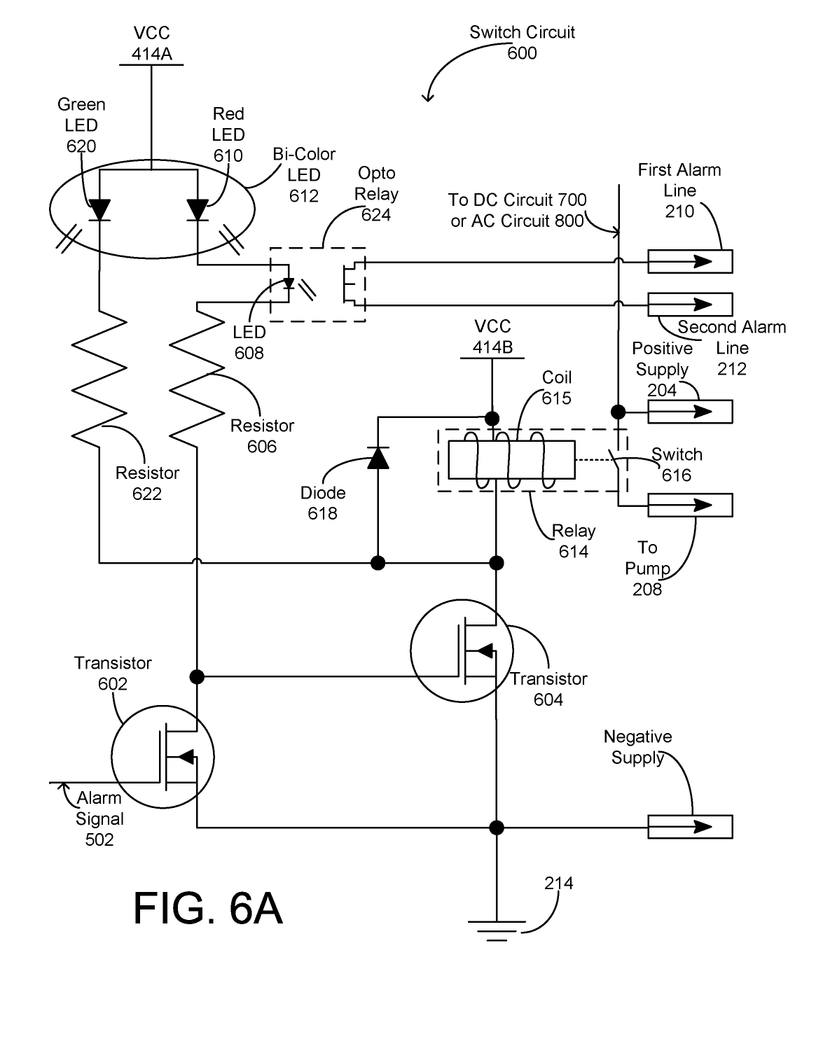

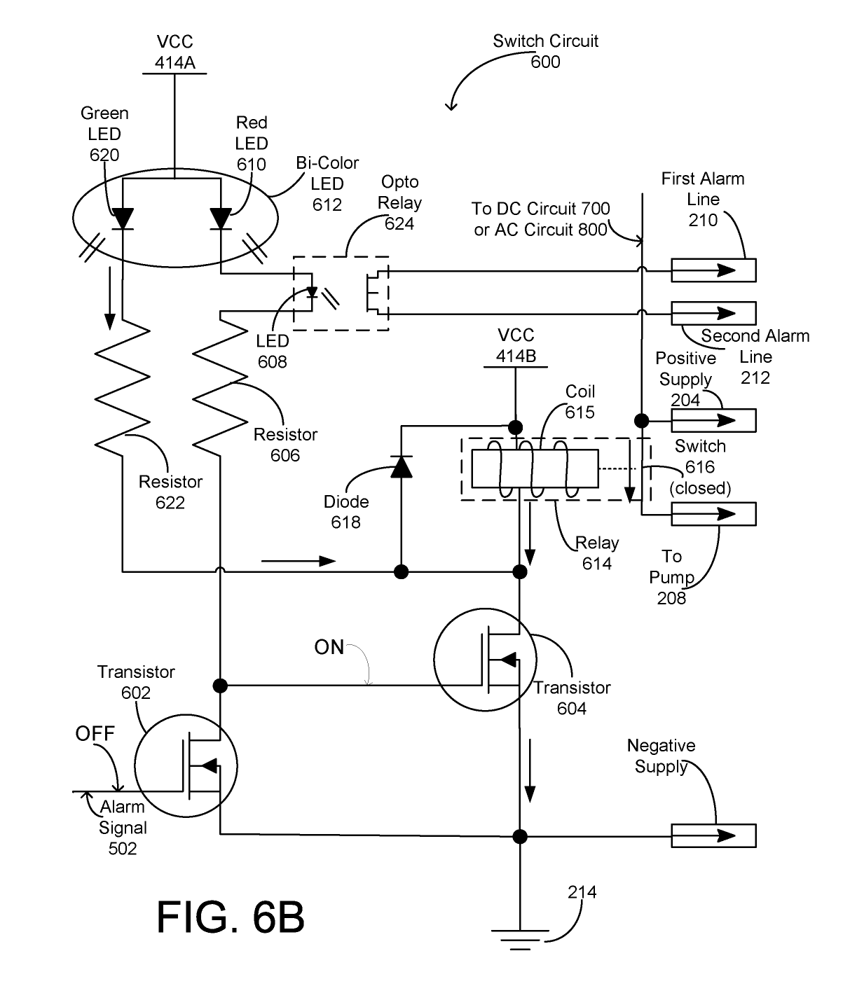

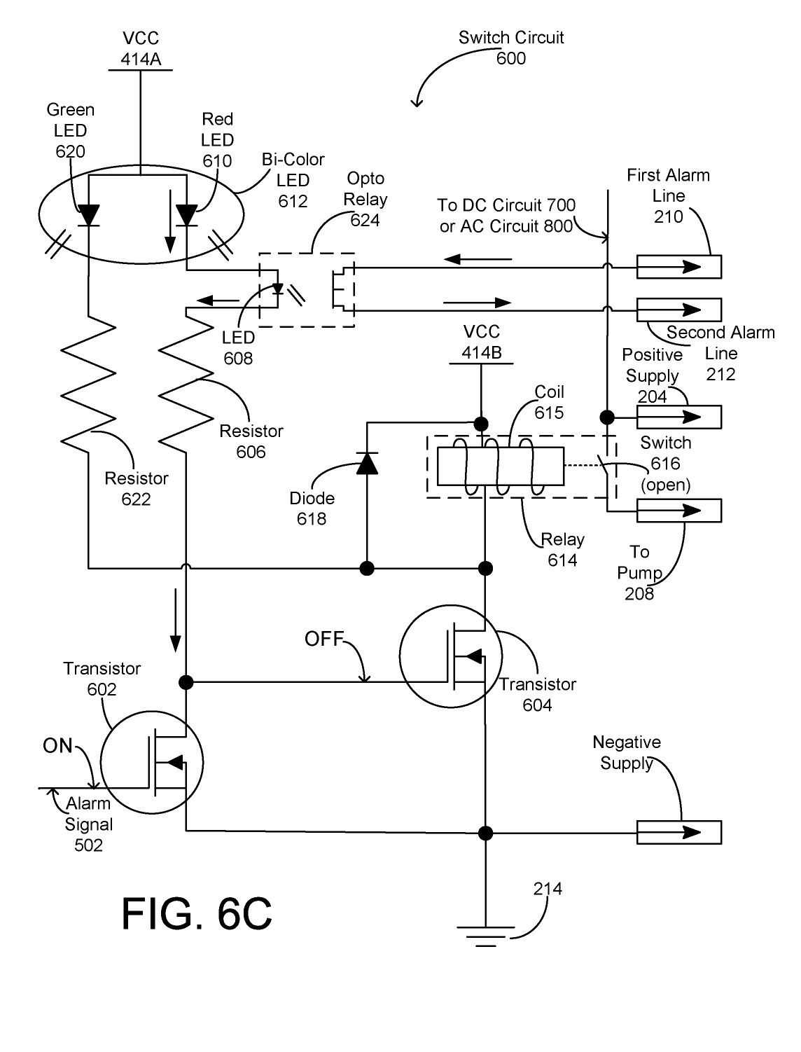

The water level detector 102 may provide a positive power supply 208 to the pump 104. The positive power supply 208 may be provided to the pump 104 from a switch circuit included in the water level detector 102; the switch circuit is discussed below with reference to FIGS. 3 and 6. The water level detector 102 may provide conductivity to the horn 202 via alarm lines 210, 212, allowing the horn to turn on when the a switch circuit of the water level detector is an “alarm” state (described below with reference to FIG. 6C. The alarm lines 210, 212 may be activated and/or controlled by the switch circuit. The water level detector 102 may also share a ground 214 line with the pump 104, according to an example embodiment.

FIG. 3 is a block diagram of the water level detector 102 according to an example embodiment. In an example embodiment, the water level detector 102 may receive water which is en route to the pump 104 (not shown in FIG. 1). The water level detector 102 may, for example, receive the water from either or both of the water tanks 108, 110 (not shown in FIG. 1). The water may pass through the water level detector 102 and travel to the pump 104. The pump 104 may, for example, pull the water from the water tank(s) 108, 110 by suction techniques, air pressure differentials, or other mechanical means.

The water level detector 102 may include a chamber 302. The chamber 302 may be made of metal, plastic, glass, wood, or other waterproof material. The chamber 302 may hold some of the water as the water passes through the water level detector 102 en route to the pump 104. The chamber 302 may, for example, prevent the water from exiting the chamber 302 and/or water level detector 102 except through preconfigured openings (discussed below).

In an example embodiment, the chamber 302 may include one or more sidewalls 304A, 304B. In an example in which the chamber 302 is rectangular, the chamber 302 may include front, back, left, and right sidewalls 304A, 304B. In an example in which the chamber 302 is circular or cylindrical, the sidewalls 304A, 304B may be continuous with each other. The sidewalls 304A, 304B may be waterproof, and may prevent the water from exiting the chamber 302 and/or water level detector 102 other than through the preconfigured openings.

The chamber 302 may also include a bottom portion 306 and a top portion 308. The bottom portion 306 may be mounted onto a bottom of the sidewalls 304A, 304B, and the top portion 308 may be mounted onto a top of the sidewalls 304A, 304B. The bottom portion 306 and top portion 308 may be sealed to the sidewalls 304A, 304B to prevent water from exiting the chamber 302 and/or water level detector 300 other than through the preconfigured openings.

The preconfigured openings of the chamber 302 may include a first opening 310 and a second opening 312. The first and second openings 310, 312 may include simple holes or apertures in the sidewalls 304A, 304B, or may include valves or structures configured to receive hoses or tubes. The first and second openings 310, 312 may, for example, be configured to lock or seal with hoses or tubes to allow water to enter or exit through the hose or tube, but not leak. In an example embodiment, the first opening 310 may be connected to a tube which receives water from a water tank, and the second opening 312 may be connected to a tube which sends water to the pump.

In an example embodiment, the first opening 310 or inlet port, which may receive water from the water tank, may be lower (or farther from the top portion 308) than the second opening 312 or outlet port, which may be connected to the pump 104 (shown in FIGS. 1 and 2). The lower placement of the first opening 310 may allow water to exit the chamber 302 and flow back into the water tank(s) 108, 110 if the water supply in the water tank(s) 108, 110 is low. The water in the chamber 302 may then be below a threshold for normal operation.

The water level detector 102 may also include a shaft 314. The shaft 314 may include an elongated member, such as a cylinder. The shaft 314 may be made of a durable material, such as wood, metal, or plastic. The shaft 314 may extend from the top portion 308 of the chamber 302 to the bottom portion 306 of the chamber 302. The shaft 314 may be secured to the top portion 308 and/or bottom portion 306 by glue, welding, or by friction or pressure. Or, the chamber 302, including the sidewalls 304A, 304B, bottom portion 306, and top portion 308, may be manufactured with the shaft 314 as a single component, such as by injection molding.

The water level detector 102 may also include a flotation device 316. The flotation device 316 may have a density less than the density of water, causing the flotation device 316 to float when water enters the chamber 302. The flotation device 316 may, for example, float to a height within the chamber 302 roughly equal to the water level. The height of the flotation device 316 within the chamber 302 may be related to the water level traveling through the pump. When the pump is primed, the flotation device 316 may be at or near the top portion 308 of the chamber 302. When the pump has lost prime, the flotation device 316 may fall below the top portion 308 of the chamber 302.

In an example embodiment, the flotation device 316 may be configured to slide along the shaft 314. The flotation device 316 may, for example, include a hole or aperture configured to receive the shaft 314. The hole or aperture in the flotation device 316 may match the shape of the shaft 314, or the hole or aperture may be larger than the shaft 314. In the example shown in FIG. 1, the dashed lines inside the flotation device 316 show the portion of the shaft 314 which extends through the flotation device 316. The flotation device 316 may slide along the shaft 314 at any point from the bottom portion 306 of the chamber 302 to the top portion 308 of the chamber 302, depending on the water level inside the chamber 302.

In another example embodiment, the water level detector 102 may not include the shaft 314, and the flotation device 316 may float freely within the chamber 302. In this example, the diameter of the flotation device 316 along its shortest axis may be longer than the greatest diameter of either the first opening 310 or the second opening 312, to prevent the flotation device 316 from exiting the chamber 302 through either the first opening 310 or the second opening 312.

The flotation device 316 may include magnetic material. The magnetic material may, for example, include a ring magnet which encircles the shaft 314. The magnetic material may create or alter a magnetic field within a proximity of the flotation device. The creation or alteration of the magnetic field may be detected by circuitry 318.

The water level detector 102 may include circuitry 318. The circuitry 318 may be located in or above the top portion 308 of the chamber 302. The circuitry 318 and top portion 308 of the chamber 302 may be configured to prevent water from the chamber 302 from contacting the circuitry 318.

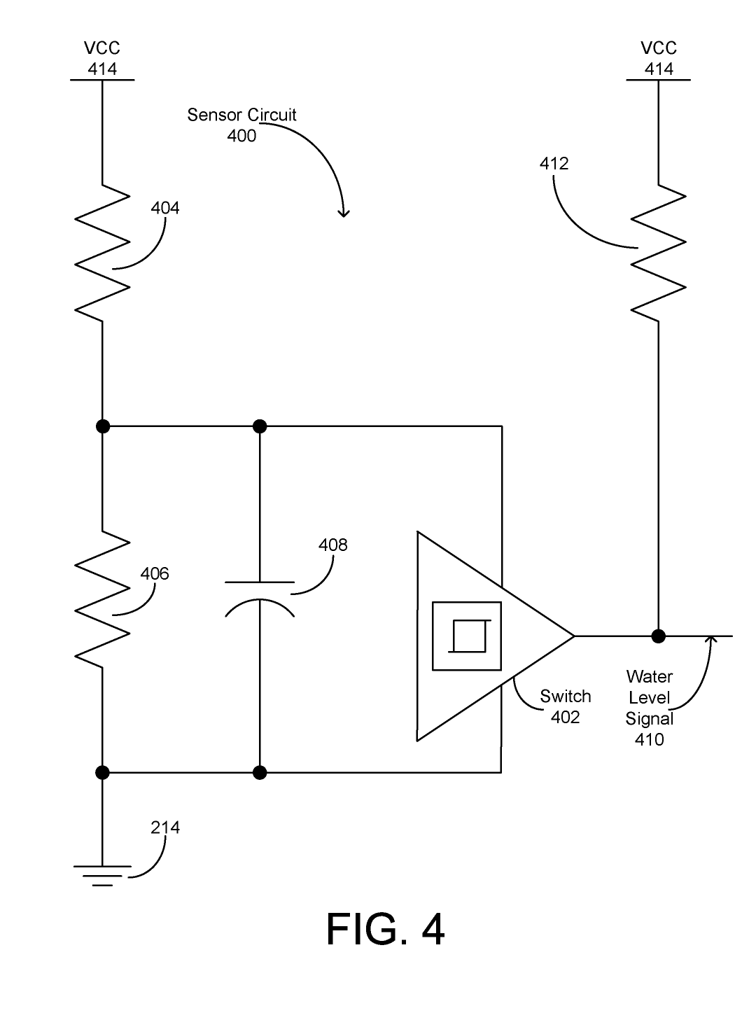

In an example embodiment, the circuitry 318 may include a magnetic sensor circuit (an example of which is shown in detail in FIG. 4). The magnetic sensor circuit may detect the creation or alteration of the magnetic field caused by the magnetic material of the flotation device 316 when the flotation device 316 is in proximity with the top portion 308 of the chamber 302. Thus, the magnetic sensor circuit may determine whether the flotation device 316 is in proximity with the top portion 308 of the chamber 302. The magnetic sensor circuit may output or send a water level signal based on the determination of whether the flotation device 316 is in proximity with the top portion 308 of the chamber 302. The water level signal may indicate whether the flotation device 316 is in proximity with the top portion 308 of the chamber 302.

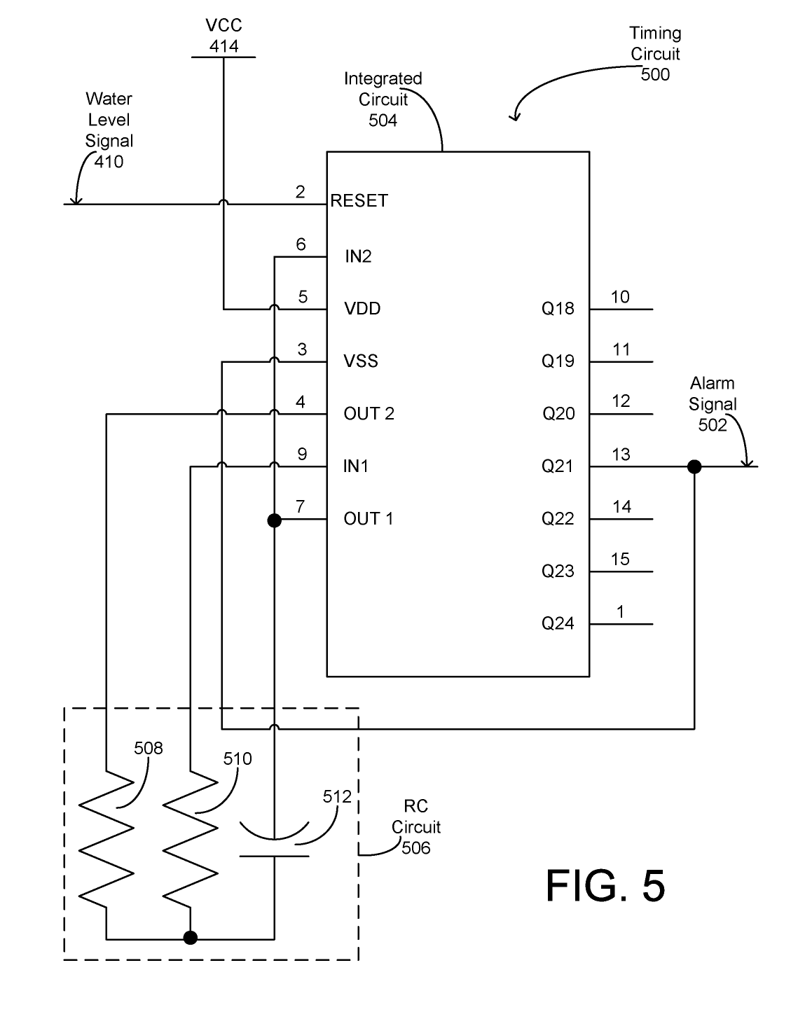

The magnetic sensor circuit may send the water level signal to a timing circuit, which may be included in the circuitry 318. If the timing circuit receives a water level signal from the magnetic sensor circuit indicating that the water level is low, the timing circuit (an example of which is shown in detail in FIG. 5) may start a timer which expires after a predetermined period of time. If the timer expires before the water level signal changes (which would indicate that the water level is no longer low), then the timing circuit may output or send an alarm signal. Thus, the timing circuit may output or send the alarm signal based on the water level signal continually indicating a low water level for the predetermined period of time.

The timing circuit may send the alarm signal to a switch circuit (an example of which is shown in detail in FIG. 6). The switch circuit may remove power from an external device, such as the pump, based on the alarm signal. The switch circuit may also turn on an audible device, such as a horn, based on the alarm signal, warning the user that the water level is low and the water level detector is turning off the external device.

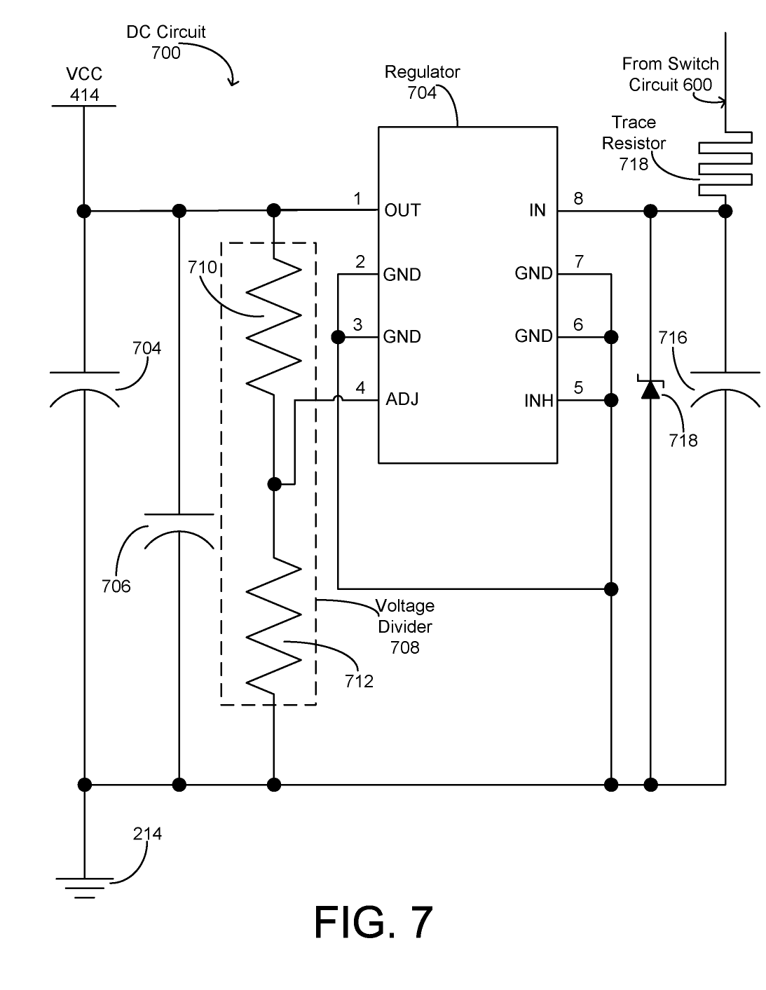

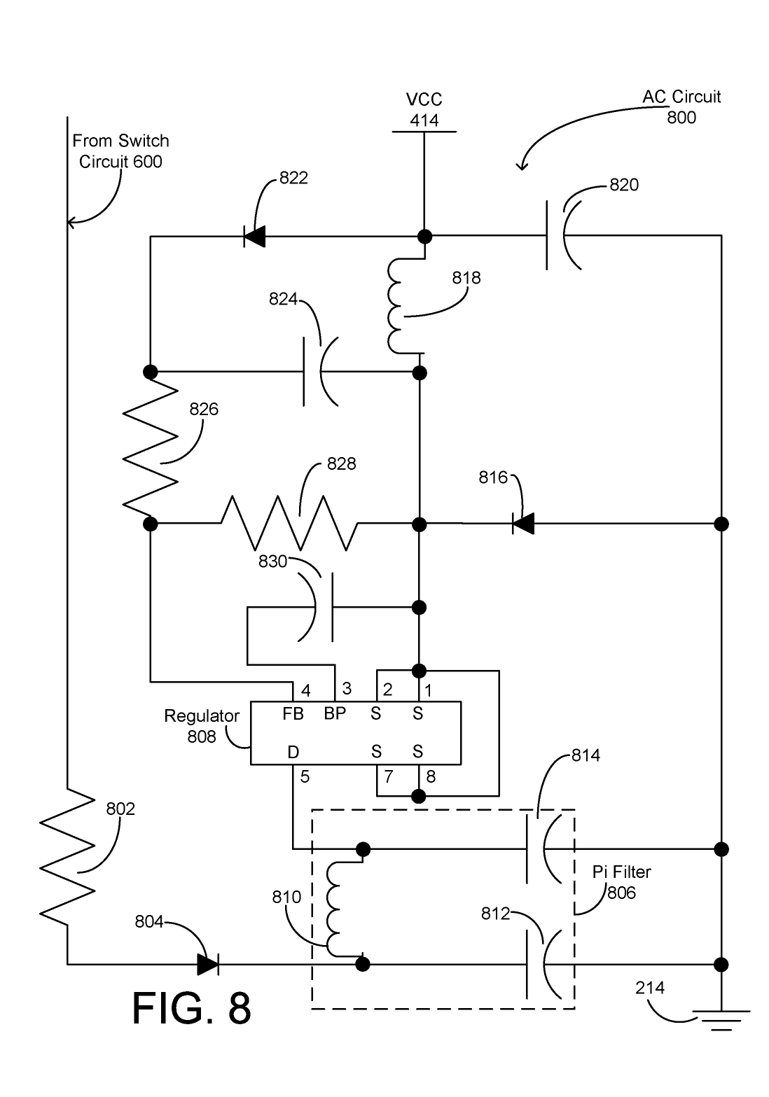

FIG. 4 is a circuit diagram of a sensor circuit 400 according to an example embodiment. The sensor circuit 400 may receive power from a power supply VCC 414, which may be provided by a DC circuit (an example of which is shown and described with reference to FIG. 7) or an AC circuit (an example of which is shown and described with reference to FIG. 8).

The sensor circuit 400 may include a magnetic switch 402. The magnetic switch 402 may include, for example, a hall-effect switch or a reed switch responsive to the magnetic field created or altered by the flotation device 316 described with reference to FIG. 3. In an example embodiment, the magnetic switch 402 may include an A3211 hall-effect switch, which may turn off in response to either a north pole or south pole magnetic field from the magnetic material included in the flotation device 316. In this example, the magnetic switch may operate with less than 15 microwatts, a supply voltage of 2.75 volts, and may include internal timing circuitry which activates the magnetic switch 402 for 45 microseconds drawing 2.0 milliamperes and deactivate the magnetic switch 402 for a remainder of a period of 45 milliseconds, drawing 8 microamperes during the deactivated period.

A first resistor 404 and a second resistor 406 form a voltage divider and set an operating voltage for the magnetic switch 402. A first input of the magnetic switch may be coupled between the first resistor 404 and the second resistor 406. In an example in which the power supply VCC 414 is 12 volts, the first resistor 404 (R7) has resistance 100 kiloohms, and the second resistor (R11) has resistance 40.2 kiloohms, the operating voltage (Vs) for the magnetic switch 402 may be 3.4 volts, as shown by the following equations:

Vs=Vcc(R11/(R7+R11))

or

Vs=12.0(40.2K/(100K+40.2K))=3.44≈3.4

The sensor circuit 400 may also include a capacitor 408. The capacitor 408 may reduce a voltage ripple during the 45 microsecond active state of the magnetic switch 402. The capacitor 408 may have a capacitance of 0.15 microfarads. In an example embodiment, the second resistor 406, the capacitor 408, and a second input of the magnetic switch may be coupled to ground 214.

The magnetic switch 402 may output a water level signal 410. When no magnetic field is detected, the magnetic switch may act as a closed circuit with respect to the node of the water level signal 410 and ground (such as by allowing current to flow through an output stage such as an N-channel MOSFET), bringing the water level signal 410 to ground 214 or zero ‘0’ (LO), indicating that the water level is too low. In an example embodiment, when the water level is sufficiently high to cause the flotation device 316 and its magnetic material be close enough to the circuitry 318 shown in FIG. 3 to activate the magnetic switch 402, the magnetic switch 402 may act as an open circuit with respect to the node of the water level signal 410 and ground (such as by preventing current flowing through the output stage which may be an N-channel MOSFET), bringing the water level signal to the power supply VCC 414.

The sensor circuit 400 may include a third resistor 412 coupled between the node of the water level signal 410 and the power supply VCC 414. In an example embodiment, the third resistor 412 may have a resistance of 100 kiloohms. The third resistor 412, which may act as a pull up resistor, may pull the water level signal 410 high when the switch 402 is open. With the magnetic switch 402 acting as an open circuit between the water level signal 410 and ground 214, the power supply VCC 414 and the third resistor 412 may pull the water level signal 410 to VCC 414 or one ‘1’ (HI), indicating that the water level is sufficiently high.

FIG. 5 is a circuit diagram of the timing circuit 500 according to an example embodiment. The timing circuit 500 may receive the water level signal 410 from the sensor circuit 400. If the timing circuit 500 receives a water level signal 410 indicating that the water level is too low (such as a zero ‘0’ LO discussed above), the timing circuit 500 may start a countdown timer. The countdown timer may be reset at any time before expiration if the timing circuit 500 receives a water level signal 410 indicating that the water level is sufficiently high (such as a one ‘1’ HI discussed above). If the countdown timer expires before the timing circuit 500 receives a water level signal 410 indicating that the water level is sufficiently high, then the timing circuit 500 may send an alarm signal 502 to the switch circuit 600 (shown and discussed with reference to FIG. 6).

The timing circuit 500 may include an integrated circuit 504. The integrated circuit 504 may perform the countdown timing functions and provide the alarm signal 502 based on the water level signal 410 as discussed above. The integrated circuit 504 may receive power from the power supply VCC 414.

In an example embodiment, the integrated circuit 504 may include a twenty-four stage frequency divider, such as an MC14521 integrated circuit. In example, the integrated circuit 504 may receive the water level signal 410 at a RESET pin 2, and may receive the power at a VDD pin 5. The integrated circuit 504 may provide the alarm signal 502 at a Q18, pin 10, Q19 pin 11, Q20 pin 12, Q21 pin 13, Q22 pin 14, Q23 pin 15, or Q24 pin 1, depending on the desired time delay for the countdown timer to provide the alarm signal 502. The node of the alarm signal 502 may also be coupled to a VSS pin 3. With the VSS pin 3 at LO, the clock may start.

With the RESET pin 2 at HI, all the Q pins may be at ground, zero ‘0’ or logic level LO. The time delay may be associated with an RC oscillator included in the integrated circuit 504, and may be determined by dividing a frequency of a free-running RC circuit 506 by a binary number associated with the Q pin output. The frequency may be set by the RC circuit 506, which may include a first resistor 508, which may have a resistance of 12.4 kiloohms in an example embodiment, a second resistor 510, which may have a resistance of 40.2 kiloohms in an example embodiment, and a capacitor 512, which may have a capacitance of 0.001 microfarads in an example embodiment. The frequency may be set in accordance with the following equations:

Fosc=Qn-1/Delay=131,072/3.75=34.952 KHz

R9=1/2.3×C6×Fosc

R10=≧2×R9

let

C6=0.001 μF

then

R9=1/2.3×0.001 μF×34.952 KHz=12.44K≈12.4K

and

R10=40.2K

In an example with seven Q-values (18-24, corresponding to pins 10-15 and 1), seven fixed time delays may be available for the timing circuit to countdown before providing the alarm signal 502 indicating that the water level has been too low for the predetermined time. The time delay may be determined according to the following equations:

Delay=Qn-1/Fosc

Fosc=34.952 KHz

or

Delay1=2¹⁸⁻¹/34.952 KHz=131,072/34.952 KHz=3.75

Delay2=2×Delay1=7.5

Delay3=2×Delay2=15

Delay4×2×Delay3=30

Delay5×2×Delay4=60

Delay6×2×Delay5=120

Delay7×2×Delay6=240

In the example shown in FIG. 5, Q21 pin 13 is used, for a time delay of 30 seconds. However, the time delay may be selected as any of 3.75 seconds, 7.5 seconds, 15 seconds, 30 seconds, 60 seconds, 120 seconds, or 240 seconds. Other time delays may be made available by changing the RC circuit 506, such as by adjusting the values of the first resistor 508, the second resistor 510, and/or the capacitor 512.

If the magnetic switch 402 detects insufficient water levels in the chamber 302 and sends a water level signal 410 zero ‘0’ or LO to the integrated circuit 504, the RESET pin 2 will receive the water level signal 410, and the integrated circuit's 504 clock will start. If the clock expires before the water level signal 410 goes to one ‘1’ or HI, the Q output (such as Q21 pin 13) or alarm signal 502 will go to one ‘1’ or HI and disable the clock or RC oscillator of the integrated circuit. The Q output or alarm signal 502 may remain at one ‘1’ or HI until the magnetic switch 402 detects sufficient water in the chamber 302 and sends a water level signal 410 one ‘1’ or HI to the integrated circuit 504, which may bring the Q output or alarm signal 502 of the integrated circuit 504 back to zero ‘0’ or LO. Or, if the power supply VCC 414 is interrupted, the timing cycle may restart.

FIG. 6A is a circuit diagram of a switch circuit 600 according to an example embodiment. The switch circuit 600 may receive the alarm signal 502 from the timing circuit 500. The switch circuit 600 may receive power from the power supply VCC at two nodes 414A, 414B. The switch circuit 600 may control whether power is supplied to the pump 104 and any alarm device, such as the horn 202.

The node of the alarm signal 502 may be coupled to a gate of a first transistor 602, thereby allowing the alarm signal 502 generated by the integrated circuit 504 of the timing circuit 500 to control the first transistor 602. The first transistor 602 may include a MOSFET, such as an N-channel MOSFET. When the alarm signal 502 is zero ‘0’ or LO, the first transistor 602 will be turned off, and the switch circuit 600 may be considered to be in a normal state. When the alarm signal 502 is one ‘1’ or HI, the first transistor 602 will be turned on, and the switch circuit 600 may be considered to be in an alarm state.

FIG. 6B is a circuit diagram of the switch circuit 600 in the normal state according to an example embodiment. In FIG. 6B, the arrows show the flow of current. With the alarm signal 502 at zero, the first transistor 602 may be turned off (high impedance state), and no current may flow through the first transistor 602. A voltage at a gate of a second transistor 604, which may include a MOSFET such as an N-channel MOSFET, may be equal to the voltage of the power supply VCC 414A minus voltage drops across a second transistor 604, a first resistor 606, an LED 608, and a red LED 610 (which may be included in a bicolor LED 612). With no current flowing through the first transistor 602, the voltage drops across the first resistor 606, the LED 608, and the red LED 610 may be sufficiently small that the voltage at the gate of the second transistor 604 is large enough to turn the second transistor 604 on (low impedance state).

With the second transistor 604 turned on, current may flow from the power supply VCC 414B through coil 615 included in a relay 614 and the second transistor 604 to ground 214. The relay 614 may include, for example, a high-power relay with a contact rating of about twenty amperes. When current flows through the coil 615 of the relay 614, the relay 614 may energize and generate a magnetic field which causes a switch 616, which is included in the relay 614, to close. When current stops flowing through the coil 615 of the relay 614, the relay 614 may become de-energized, and the magnetic field may collapse, generating a counter electro motive force (CEMF), which may produce a voltage spike. A diode 618, which may include a high-speed switching diode, may be coupled to opposite nodes of the relay 614, and may clamp the CEMF to safe levels.

The switch 616, which may be included in the relay 614, may include a switch which opens or closes in response to the magnetic field generated by the coil of the relay 614, such as a reed switch. A first side of the switch 616 may be coupled to the positive supply 204 and to either a DC circuit (an example of which is shown and described with reference to FIG. 7) or an AC circuit (an example of which is shown and described with reference to FIG. 8), which in turn provides the power supply VCC 414 to the sensor circuit 400, the timing circuit 500, and the alarm circuit 600. While the terms, “positive supply,” and, “negative supply,” are used herein, it is to be noted that these may be considered a “supply,” and, “neutral,” respectively, when the water level detector 102 operates under AC power. A second side of the switch may supply power 208 to the pump 104. In an example embodiment, when the switch 616 is closed, the switch circuit 600 may allow power 208 to be supplied to the pump 104, but when the switch 616 is open, the switch circuit 600 may prevent power 208 from being supplied to the pump 104. In other example embodiments, the switch circuit 600 may allow power to be supplied to the pump 104 when a switch is open, and prevent power from being supplied to the pump 104 when a switch is closed.

When the second transistor 604 is turned on, current may also flow from the power supply VCC 414A through a green LED 620 (which may be included in the bicolor LED 612), through a second resistor 622, and through the second transistor 604 to ground 214. With current flowing through the green LED 620, the green LED 620 may light up, indicating that the water level detector 102 is in an ‘on’ or normal condition, and power may be supplied to the pump 104. The green LED 620 and the red LED 610 may be included in the bicolor LED 612. In the example embodiment shown in FIG. 6, the bicolor LED 612 may light up green when the switch circuit 600 is in the normal state, and the bicolor LED 612 may light up red when the switch circuit 600 is in the alarm state.

FIG. 6C is a circuit diagram of the switch circuit 600 in the alarm state according to an example embodiment. In FIG. 6C, the arrows show the flow of current. In this example, the alarm signal 502 may be one ‘1’ or HI, turning the first transistor 602 on (low impedance). With the first transistor 602 turned on, the voltage at the gate of the second transistor 604 may be brought to ground, turning the second transistor 604 off (high impedance). With the second transistor 604 turned off, current may stop flowing through the relay 614, causing the magnetic field generated by the coil of the relay 614 to collapse, and causing the switch 616 to close, and taking power 208 away from the pump 104. With the second transistor 604 turned off, current may also stop flowing through the green LED 620 and the second resistor 622, turning the green LED 620 off.

With the first transistor 602 turned on, current may flow from the power supply VCC 414A through the red LED 610, the LED 608, the first resistor 606, and the first transistor 602 to ground 214. The current flowing through the red LED 610 may turn the red LED 610 on, causing the bicolor LED 612 to emit red light.

The LED 608 may be included in an opto-relay 624 coupled to the first alarm line 210 and the second alarm line 212. The opto-relay 624 may include a switch which is responsive to the light emitted by the LED 608. The switch may close in response to the LED 608 turning on, closing a circuit between the first alarm line 210 and the second alarm line 212, turning on an alarm element, such as the horn 202 (shown in FIG. 2), and alerting a user that the water level detector 102 is in the alarm state.

FIG. 7 is a circuit diagram of a DC circuit 700 according to an example embodiment. The DC circuit 700 may receive power from the positive supply 204 shown in FIG. 2 switch circuit 600 of FIG. 6, and may provide power to the power supply VCC 414, which provides power to the sensor circuit 400, the timing circuit 500, and the alarm circuit 600. The DC circuit 700 may include a regulator 702, which may include an adjustable output voltage regulator, such as an LM2931. The regulator 702 may, for example, supply output currents in excess of 100 milliamperes, and may feature a low bias current, such as 0.4 milliamperes at 10 milliamperes output. The regulator 702 may protect the pump 104 (shown in FIGS. 1 and 2) from fault conditions, such as fault conditions caused by a reversed battery connection, battery jump-starts, or excessive line transients during load dump.

The regulator 702 may provide power to the power supply VCC 414, such as at an OUT pin 1. The DC circuit 700 may include a filter capacitor 704 coupled between the node shared by the power supply VCC 414 and the OUT pin 1 and ground 214. The filter capacitor 704 may have a capacitance of 1000 microfarads in an example embodiment, and may reduce variations in the voltage provided to the regulator 702. The DC circuit 700 may also include a stabilizing capacitor 706 coupled between the node shared by the power supply VCC 414 and the OUT pin 1 and ground 214. The stabilizing capacitor 706 may have a capacitance of 0.15 microfarads, and may stabilize the voltage provided to the regulator 702.

The DC circuit 700 may also include a voltage divider 708 coupled between the node shared by the power supply VCC 414 and the OUT pin 1 and ground 214. The voltage divider 708 may include a first resistor 710 and a second resistor 712. A ratio between the first resistor 710 and the second resistor 712 may set an output voltage of the regulator 702, which provides the power supply VCC 414 to the sensor circuit 400, the timing circuit 500, and the alarm circuit 600. An ADJ pin 4 of the regulator 702 may be coupled between the first resistor 710 and the second resistor 712. In an example in which the voltage at the ADJ pin 4 is 1.2 volts, the first resistor 710 has resistance 11.3 kiloohms, and the second resistor 712 has resistance 100 kiloohms, the voltage of the power supply VCC 414 (or V_{O}) may be set as follows:

Vo=Vef(1+R2/R1)

or

Vo=1.2(1+100K/11.3K)=11.82≈12

The DC circuit 700 may also include a diode 714 coupled between an IN pin 8 of the regulator 702 and ground 214. The diode 714 may include a transient voltage suppressor, such as a 600 Watt unipolar transient voltage suppressor with a standoff voltage of 40 volts. The DC circuit 700 may also include a bypass filter capacitor 716 in parallel with the diode 714, coupled between an IN pin 8 of the regulator 702 and ground 214. The bypass filter capacitor 716 may, for example, have a capacitance of 0.15 microfarads. The DC circuit 700 may also include a trace resistor 718 coupled between the IN pin 8 and the positive supply 204. The trace resistor 718 may, for example, use a printed circuit board on which the sensor circuit 400, timing circuit 500, alarm circuit 600, and/or DC circuit 700 may be mounted, to create a high power resistor capable of dissipating transient power. The trace resistor 718 may, for example, include two ounces of copper, be 25 thousandths of an inch wide, twelve inches long, and have a resistance of approximately 0.01 ohms. The diode 714, bypass filter capacitor 716, and/or trace resistor 718 may serve as a power surge suppressor, protecting the water level detector 102 from high voltage surges.

FIG. 8 is a circuit diagram of an AC circuit 800 according to an example embodiment. In this example, the AC circuit 800 may receive power from the supply 204.

The AC circuit 800 may receive power from the supply 204 via a first resistor 802. The first resistor 802 may include, for example, a flame-proof, fusible, wire-wound resistor, and may have a resistance of, for example, 8.2 ohms. The first resistor 802 may absorb energy, attenuate noise, and/or keep current levels down to safe levels.

The AC circuit 800 may also include a first diode 804. The first diode 804 may include a rectifier diode, such as a 1N4007 rectifier diode, and may prevent current from flowing back toward the positive supply.

The AC circuit 800 may include a pi filter 806 coupled to the first diode 804, to ground 214, and to a regulator 808. The pi filter 806 may reduce current ripples. The pi filter may include a first inductor 810 coupled to the first diode 804 and to a drain (‘D’) pin 5 of the regulator. The first diode 804 may have an inductance of, for example, 1 millihenry. The pi filter 806 may also include a first capacitor 812 and a second capacitor 814. The first and second capacitors 812, 814 may be coupled to opposite ends of the first inductor 810, and to ground 214. The first and second capacitors 812, 814 may have capacitances of, for example, 4.7 microfarads.

The regulator 808 may include an off-line voltage regulator, such as an LNK 304. The regulator 808 may receive power from the D pin 5. S pins 1, 2, 7, and 8 may be coupled to a second diode 816. The second diode 816 may include a freewheeling diode such as a UF4005, and may have a reverse recovery time (trr) of approximately 75 nanoseconds, which may allow discontinuous mode operation. The S pins 1, 2, 7, 8 may also be coupled to a second inductor 818, which may store energy and provide a relatively constant current to the power supply VCC 414.

A third capacitor 820 may be coupled to the second diode 816, the pi filter 806, and ground 214 at one end, and to the second inductor 818, a third diode 822 (which may be similar to the second diode 816), and to the power supply VCC 414 at the other end. The third capacitor 820 may serve as an output filter capacitor, and may limit output voltage ripple at the power supply VCC 414. The third capacitor 820 may have a capacitance, for example, of 1000 microfarads.

The AC circuit 800 may include a fourth capacitor 624 coupled to the S pins 1, 2, 7, 8 and the second inductor 818 at one end, and to the third diode 822 at the other end. The voltage across the fourth capacitor 624 may be regulated by a resistor divider. The resistor divider may include a second resistor 826 coupled to the fourth capacitor 824 and to an FB pin 4 of the regulator 808, which may have a resistance of 13 kiloohms, and a third resistor 828 coupled to the S pins 1, 2, 7, 8 of the regulator 808 and to the FB pin 4 of the regulator 808. The resistances of the second resistor 826 and the third resistor 828 may determine the voltage of the power supply VCC 414 as a function of the voltage at FB pin 4. The following equations show the voltage of the power supply VCC 414 (V_{O}) as a function of the voltage at the FB pin 4 (V_{REF}):

Vo=Vref(1+R2/R3)

or

Vo=1.65(1+13K/2/05K)=12.11≈12

The AC circuit 800 may also include a fifth capacitor 830 coupled between the S pins 1, 2, 7, 8 and a BP pin 3. The fifth capacitor 830 may prevent voltage spikes at the S pins 1, 2, 7, 8.

The regulator 808 may maintain the voltage at the power supply VCC 414 by skipping switching cycles. As the voltage at the power supply VCC 414 rises, the current into the FB pin 4 will rise. If the current into the FB pin 4 exceeds a threshold current I_{FB}, subsequent cycles may be skipped, reducing the current into the FB pin 4 below I_{FB}. Thus, as the output load from the power supply VCC 414 is reduced, more cycles may be skipped, whereas if the load increases, fewer cycles may be skipped. If no cycles are skipped during a predetermined period, such as 50 milliseconds, the regulator 808 may enter an auto-start mode, in which the regulator 808 may limit average output power to less than a maximum overload power, such as 6% of the maximum overload power. The AC circuit 800 may thereby receive power from an AC source at the power supply and provide a steady DC power supply at VCC 414.

Implementations of the various techniques described herein may be implemented in digital electronic circuitry, or in computer hardware, firmware, software, or in combinations of them. Method steps may be performed by one or more programmable processors executing a computer program to perform functions by operating on input data and generating output. Method steps also may be performed by, and an apparatus may be implemented as, special purpose logic circuitry, e.g., an FPGA (field programmable gate array) or an ASIC (application-specific integrated circuit). While certain features of the described implementations have been illustrated as described herein, many modifications, substitutions, changes and equivalents will now occur to those skilled in the art. It is, therefore, to be understood that the appended claims are intended to cover all such modifications and changes as fall within the true spirit of the embodiments of the invention.

What is claimed is:

1. An apparatus comprising:
a chamber configured to receive water through an first opening and allow water to exit through a second opening, the chamber being configured to prevent the water from exiting the chamber other than through the first opening or the second opening;
a flotation device inside the chamber, the flotation device including a magnetic material;
a magnetic sensor circuit configured to determine whether the flotation device is in proximity with a top portion of the chamber, the magnetic sensor circuit being configured to output a water level signal to a timing circuit based on the determining;
a timing circuit configured to output an alarm signal to a switch circuit based on the water level signal continually indicating a low water level for a predetermined period of time; and
the switch circuit configured to remove power from an external device based on the alarm signal.

2. The apparatus of claim 1, wherein:
the apparatus further comprises a shaft extending from a bottom portion of the chamber to the top portion of the chamber; and
the flotation device is configured to slide along the shaft.

3. The apparatus of claim 1, wherein the magnetic sensor circuit is included in the top portion of the chamber.

4. The apparatus of claim 1, wherein the magnetic sensor circuit includes a hall-effect switch configured to output the water level signal to the timing circuit based on the determining whether the flotation device is in proximity with the top portion of the chamber.

5. The apparatus of claim 1, wherein the magnetic sensor circuit includes a reed switch configured to output the water level signal to the timing circuit based on the determining whether the flotation device is in proximity with the top portion of the chamber.

6. The apparatus of claim 1, wherein the timing circuit comprises a frequency divider coupled with an RC circuit.

7. The apparatus of claim 1, wherein the switch circuit comprises:
a transistor controlled by the alarm signal output by the timing circuit; and
a relay switch controlled by the transistor, the relay switch being configured to remove power from the external device based on the alarm signal.

8. The apparatus of claim 1, wherein the switch circuit is further configured to turn on an audible device based on the alarm signal.

9. The apparatus of claim 1, wherein the switch circuit comprises:
first transistor controlled by the alarm signal;
a first visual status indicator controlled by the first transistor;
a second transistor controlled by the first transistor; and
a second visual status indicator controlled by the second transistor.

10. The apparatus of claim 1, wherein the switch circuit is configured to remove the power from an electrical water pump based on the alarm signal.

11. A boat comprising:
a hull configured to cause the boat to float;
at least one water tank configured to store water;
a pump configured to pump water from the at least one water tank; and
a water level detector configured to receive the water being pumped by the pump from the at least one water tank, the water level detector including:
means for detecting whether a water level of the water being pumped by the pump from the at least one water tank has fallen below a predetermined threshold;
means for determining whether the water level has fallen below the predetermined threshold for a predetermined period of time; and
means for removing power from the pump based on the water level falling below the predetermined threshold for the predetermined period of time.

12. The boat of claim 11, wherein the means for detecting whether the water level has fallen below the predetermined threshold includes a flotation device including a magnetic material and a magnetic sensor.

13. The boat of claim 11, wherein the water level detector further includes a visual status indicator configured to indicate whether the water level has fallen below the threshold for the predetermined period of time.

14. The boat of claim 11, wherein the water level detector further includes an audible indicator configured to indicate that the water level has fallen below the threshold for the predetermined period of time.

15. A vehicle comprising:
a body configured to protect components inside the vehicle;
at least one water tank coupled to the body and configured to store water;
a pump coupled to the body and configured to pump water from the at least one water tank; and
a water level detector coupled to the body and configured to receive the water being pumped by the pump from the at least one water tank, the water level detector including:
means for detecting whether a water level of the water being pumped by the pump from the at least one water tank has fallen below a predetermined threshold;
means for determining whether the water level has fallen below the predetermined threshold for a predetermined period of time; and
means for removing power from the pump based on the water level falling below the predetermined threshold for the predetermined period of time.
